(19) United States
(12) Patent Application Publication
(10) Pub. No.: US 2019/0205332 A1
(43) Pub. Date: Jul. 4, 2019

(54) STORING AND RETRIEVING SPATIAL DATA IN/FROM A DATABASE

(71) Applicant: KONINKLIJKE PHILIPS N.V., EINDHOVEN (NL)

(72) Inventor: BAS HULSKEN, EINDHOVEN (NL)

(21) Appl. No.: 16/328,042

(22) PCT Filed: Aug. 22, 2017
(86) PCT No.: PCT/EP2017/071069

§ 371 Date: Feb. 25, 2019

(30) Foreign Application Priority Data
Aug. 25, 2016 (EP) 16185584.6

(51) Int. Cl. G06F 16/51; G06F 16/28; G06F 16/245

(52) U.S. Cl. CPC G06F 16/51; G06F 16/245; G06F 16/285

(57) ABSTRACT

A system and method are provided for storing spatial data in a key-value database. The key-value database is configured to store value data in relation to key data and to allow retrieval of the value data on the basis of the key data. The spatial data is stored such that each stored value data represents a cluster which is generated by partitioning the spatial data into blocks and grouping the blocks into clusters. The key data, or ‘key name’, of each stored value data comprises at least a coordinate-based identifier of the respective cluster which is defined with respect to a coordinate system associated with the spatial data. This allows retrieving (part of) the value data of a particular cluster by calculating (part of) the coordinate-based identifier of the cluster. There may thus be no need for a header comprising indexing information. Said storing is suited for databases which are accessed remotely, e.g., if the database is comprised on a cloud-based storage system and the system is comprised in, or the method is performed by, a client connected to the cloud-based storage system.

### FIELD OF THE INVENTION

The invention relates to a system and a method for storing spatial data in a database. The invention further relates to a system and a method for retrieving spatial data from a database. The invention further relates to a workstation or imaging apparatus comprising either or both systems, to a computer readable medium comprising instructions for causing a processor system to perform either or both methods, and to a database.

### BACKGROUND OF THE INVENTION

Digital images have increased in size over the recent years and will continue to increase in size, e.g., due to increases in spatial resolution, bit-depth and/or dynamic range of imaging sensors, due to imaging apparatuses in the medical field scanning more slices, etc. A specific yet non-limiting example is that digital slide images from digital pathology scanners may have sizes in the gigabyte range. Various other examples exist as well. As such, the storage requirements for storing such images is growing. For this and other reasons, it may be desirable to store images in databases which are able to cope with the storage requirements. Typically, such databases are hosted by distributed and scalable storage systems. Such storage systems may, but do not need to be, cloud-based storage systems, including but not limited to Amazon S3, Google cloud storage and Openstack SWIFT, which allow storing and retrieving of objects, such as files or other types of data structures.

Aside of image data, there may be other forms of spatial data which are sizeable. Here, the term ‘spatial data’ refers to multi-dimensional data having at least two spatial dimensions. It is known to store such spatial data, being in the following examples the image data of an image, in a database in the form of a single object, e.g., as a single file.

For example, U.S. Pat. No. 8,582,849 B2 describes a virtual slide which is contained in a single image file on the computer system. The file format of the single file comprises a header which is said to contain file information and a reference to a baseline image, which contains the virtual slide image in its native resolution as received from the line scanner device. The baseline image is organized as a sequence of blocks to facilitate random access. Individual blocks may be compressed, e.g., according to the JPEG2000 standard.

The inventors have considered that, for very large spatial data, the header containing indexing information, e.g., for allowing the matching of a block identifier to a position in the file, may be very large as well. For example, for spatial data of several gigabytes, the header may be hundreds of megabytes in size. As the header may need to be accessed and analyzed, this represents a significant overhead, e.g., in terms of bandwidth, which may be particularly disadvantageous when the database is accessed over a bandwidth-constrained network, such as a bandwidth-constrained access network to the internet.

U.S. Pat. No. 6,021,406 discloses a method for storing map data in a database and a method of searching the database to find objects in a given area and to find objects nearest to a location. To generate the map data, a map plane is divided into a number of squares and the squares are numbered with spatial key numbers according to a space filling curve. Objects identifying places such as restaurants or hotels are placed in a main table of the database along with one of the spatial keys (object keys) intersecting an area of the map occupied by the object. A secondary table of the database is then created with one column including object keys corresponding to the main table, and other columns identifying ranges of spatial keys for objects identified by the object keys. To search the database to find objects in a given area, ranges of spatial keys are calculated for the given area and compared with ranges in the secondary table to identify object keys. The object keys identified are then used to obtain the desired objects from the main table.

U.S. Pat. No. 6,633,688 discloses a client/server system that serves imagery to users with speed, efficiency, and desirable functionality. Clients are allocated the means to determine the image data necessary to generate views on an image. The clients issue requests for such necessary image data to servers who service the requests and send requested image data to the clients who then generate the views. The system responds quickly to changes of views resulting form user actions such as panning or zooming by enabling clients to determine which image data is needed that has not already been served and requesting service of only that data. Clients are also enabled to issue requests to cancel service of data previously requested, but unserved and no longer needed.

### SUMMARY OF THE INVENTION

It would be advantageous to obtain a system and method for storing spatial data in a database which allows parts of the spatial data to be retrieved with fewer overhead.

The following aspects of the invention involve storing spatial data in a key-value database which is configured to store value data in relation to key data and to allow retrieval of the value data on the basis of the key data. The spatial data is stored such that each stored value data represents a cluster which is generated by partitioning the spatial data into blocks and grouping the blocks into clusters. The key data of each stored value data comprises at least a coordinate-based identifier of the respective cluster which is defined with respect to a coordinate system associated with the spatial data. This allows retrieving (part of) the value data of a particular cluster by calculating the coordinate-based identifier of the cluster. There is thus no need for a header comprising indexing information.

A first aspect of the invention provides a system configured to store spatial data in a database, comprising:
a database interface configured to access the database, wherein the database is a key-value database configured to store value data in relation to key data and to allow retrieval of the value data on the basis of the key data;
a memory comprising instruction data representing a set of instructions;
a processor configured to communicate with the database interface and the memory and to execute the set of instructions, wherein the set of instructions, when executed by the processor, cause the processor to:
partition the spatial data into blocks;
group the blocks into clusters; and
store each cluster in the database by causing the processor to:
   store a respective cluster as value data in the database;
   generate an identifier of the cluster on the basis of a coordinate of the respective cluster, wherein the coordinate is defined with respect to a coordinate system associated with the spatial data;
   generate key data for the value data of the cluster, wherein the key data comprises at least the identifier of the cluster; and
   store the key data in relation to the value data in the database.

A further aspect of the invention provides a system configured to retrieve spatial data from a database, comprising:
a database interface configured to access the database, wherein the database is a key-value database configured to store value data in relation to key data and to allow retrieval of the value data on the basis of the key data, wherein the database comprises:
   stored value data each representing a respective cluster generated by partitioning the spatial data into blocks and grouping the blocks into clusters;
   stored key data for each stored value data comprising at least an identifier of the respective cluster, wherein the identifier of the cluster is generated on the basis of a coordinate of the respective cluster, wherein the coordinate is defined with respect to a coordinate system associated with the spatial data;
a memory comprising instruction data representing a set of instructions;
a processor configured to communicate with the database interface and the memory and to execute the set of instructions, wherein the set of instructions, when executed by the processor, cause the processor to:
retrieve one or more blocks of a cluster of the spatial data from the database by causing the processor to:
   generate at least part of an identifier of the cluster on the basis of a coordinate of the cluster in the coordinate system associated with the spatial data;
   query the database for key data comprising the at least part of the identifier, thereby obtaining one or more key data;
   select a key data of the one or more key data; and
   retrieve at least part of value data from the database which is stored in the database in relation to the key data.

A further aspect of the invention provides a workstation or imaging apparatus comprising either or both systems.

A further aspect of the invention provides a method for storing spatial data in a database, wherein the database is a key-value database configured to store value data in relation to key data and to allow retrieval of the value data on the basis of the key data, wherein the method comprises:
partitioning the spatial data into blocks;
grouping the blocks into clusters; and
storing each cluster in the database by:
   storing a respective cluster as value data in the database;
   generating an identifier of the cluster on the basis of a coordinate of the respective cluster, wherein the coordinate is defined with respect to a coordinate system associated with the spatial data;
   generating key data for the value data of the cluster, wherein the key data comprises at least the identifier of the cluster; and
   storing the key data in relation to the value data in the database.

A further aspect of the invention provides a method for retrieving spatial data from a database, wherein the database is a key-value database configured to store value data in relation to key data and to allow retrieval of the value data on the basis of the key data, wherein the database comprises:
stored value data each representing a respective cluster generated by partitioning the spatial data into blocks and grouping the blocks into clusters;
stored key data for each stored value data comprising at least an identifier of the respective cluster, wherein the identifier of the cluster is generated on the basis of a coordinate of the respective cluster, wherein the coordinate is defined with respect to a coordinate system associated with the spatial data;
   wherein the method comprises retrieving one or more blocks of a cluster of the spatial data from the database by:
generating at least part of an identifier of the cluster on the basis of a coordinate of the cluster in the coordinate system associated with the spatial data;
querying the database for key data comprising the at least part of the identifier, thereby obtaining one or more key data;
selecting a key data of the one or more key data; and
retrieving at least part of value data from the database which is stored in the database in relation to the key data.

A further aspect of the invention provides a computer readable medium comprising transitory or non-transitory data representing instructions arranged to cause a processor system to perform either or both methods.

A further aspect of the invention provides a computer readable medium comprising transitory or non-transitory data representing a database, wherein the database is a key-value database configured to store value data in relation to key data and to allow retrieval of the value data on the basis of the key data, wherein the database comprises:
stored value data each representing a respective cluster generated by partitioning the spatial data into blocks and grouping the blocks into clusters;
stored key data for each stored value data comprising at least an identifier of the respective cluster, wherein the identifier of the cluster is generated on the basis of a coordinate of the respective cluster, wherein the coordinate is defined with respect to a coordinate system associated with the spatial data.

The above measures in involve providing as database a so-termed key-value database which is configured to store a value, in the form of value data, in relation to a key, in the form of key data. This allows the value to be retrieved on the basis of the key. It is noted that such key-value databases are known per se in the field of databases.

In order to store the spatial data in the database, the spatial data is partitioned into blocks, with each block comprising a different portion of the spatial data. Here, the term ‘block’ refers to a number of elements of the spatial data, such as, in the non-limiting example of the spatial data being image data, pixels or voxels or wavelet coefficients, which are dealt with as a unit by the system. For example, a block may be composed of a region or tile of pixels of voxels from the image. It will be appreciated that such a region may, but does not need to have a rectangular shape; other shapes are equally possible. Moreover, the blocks may be non-overlapping as well as mutually overlapping.

Having partitioned the spatial data into blocks, the blocks are grouped into clusters. As such, each cluster may comprise a different set of blocks. The cluster is then stored in the database as a ‘key-value’ object, in that the data of the cluster is stored as value data in the database, and a corresponding key is generated and stored as key data. It is noted that both the key data and the value data is typically stored simultaneously in the database, e.g., during one ‘key-value’ store operation, even when described as individual operations.

The key is generated on the basis of an identifier, namely a coordinate-based identifier which may list or represent an encoding of a coordinate of the respective cluster, with the coordinate being defined with respect to a coordinate system associated with the spatial data. Additionally or alternatively, the identifier may be generated to list or represent an encoding of an interval which encloses the coordinate. In general, in case the key is represented by a string, the string may include the identifier. In general, the contents of a key, e.g., the key data, may in the following also be referred to as simply as ‘key name’, referring to a key being representable by a string, e.g., a linear sequence of symbols such as numerical or alphanumerical characters, or having a similar format. The cluster may thus be stored under a key name which lists or represents the coordinate of the cluster in the coordinate system of the spatial data, or the interval which encloses the coordinate.

The above measures have as effect that the spatial data is stored in a database in such a way that a cluster of blocks may be accessed on the basis of a key name which may be at least in part calculated from the coordinate of the cluster. As such, if it is known which block(s) are to be retrieved, and if the coordinate(s) of the cluster comprising the block(s) are known in the coordinate system of the spatial data, the coordinate identifier may be directly calculated, and thus at least part of the key name. The database may then be queried for the coordinate identifier. If the coordinate identifier represents the exact coordinate of the cluster, the query may return only one result, e.g., one key name, of which the value data may subsequently be retrieved. It will be appreciated that such querying may still need to take place, as other parts of the key name may be unknown, e.g., if the key name comprises data offsets of the blocks in the value data. Moreover, if the coordinate of the cluster is only approximately known, e.g., a spatial range is known rather than the exact coordinate, the database may be queried for keys are located within this spatial range, e.g., by providing a part of the identifier which represents this spatial range, and a (typically limited) number of keys may be returned by the query. There is thus no need for a header comprising indexing information. Advantageously, it may not be needed to retrieve such indexing information, which may be sizable in case the spatial data is sizable. As such, parts of the spatial data may be retrieved with fewer overhead. This may be particularly advantageous if the system is connected to the database via a bandwidth-constrained access network, e.g., an access network to the internet. A non-limiting example is that the database may be comprised on a cloud-based storage system, while the system may be comprised in, or the method may be performed by, a client connected to the cloud-based storage system.

Optionally, the set of instructions, when executed by the processor, cause the processor to further include in the key data data offsets which represent respective positions of each block, or at least of a subset, of the set of blocks of the cluster in the value data. By knowing the data offsets of each block in the value data, blocks of a cluster may be individually retrieved, thereby enabling at least a degree of random access to the blocks of the cluster. By including the data offsets in the key name, it may be sufficient to obtain access to the key name to know these data offsets. Such access to the key name may be obtained by searching for a key based on its approximate coordinate, e.g., based on the coordinate-based identifier. Key-value databases which enable searching for keys, e.g., based on key name, are known per se. As such, the key name, or in general the key data, may be returned as search results, and may be used to subsequently random access blocks of the value data which is stored under the key name.

Optionally, the coordinate system associated with the spatial data comprises at least one of:
a spatial axis indicative of a spatial coordinate of each cluster;
a color axis indicative of a color component which is represented by the spatial data comprised in a cluster; and
a wavelength axis indicative of a wavelength, or wavelength range, which is represented by the spatial data comprised in a cluster.

There may be one or more coordinate systems associated with the spatial data. A typical example is a spatial coordinate system having multiple dimensions such as width, height, depth, etc., and thus having corresponding spatial axis. Another example is that the spatial data may comprise color components, e.g., if the spatial data is image data. In this example, the color components may be considered as a coordinates on an axis, e.g., having coordinate ‘1’ for Red, ‘2’ for Green′, ‘3’ for Blue, etc. Various other aspects of the spatial data may be represented by a coordinate system. A combination of coordinate systems may together again form a coordinate system, e.g., having spatial and color component axis. Any of these coordinate systems may be used as a basis for calculating the identifier of the cluster. As such, blocks may be retrieved on the basis of the respective coordinate system.

Optionally, the set of instructions, when executed by the processor, cause the processor to generate the identifier of the cluster by encoding the coordinate using a space-filling curve function, wherein the space-filling curve function is represented by first function data in the memory. As such, the first function data may comprise instructions for the processor to perform the function. By using a space-filling curve function, the coordinates may be encoded in the identifier in a structured manner. Here, the term ‘encoding’ refers to the general concept of converting the information into a code, which may include using a particular data format for the coordinates. In particular, if the key name comprises the encoded coordinates at the beginning, the first characters of a key name may represent the coordinates of the cluster that is stored. This allows quick and efficient searching for key-value objects in the database. In particular, the keys of multiple clusters in a spatial region may be efficiently retrieved using a single query which uses as identifier the initial symbols, e.g., the most significant part, of the coordinate of the cluster. These initial symbols may, due to the encoding by a space-filling curve function, represent a spatial range in the coordinate system which is associated with the spatial data. By querying the database for key names having a coordinate identifier which starts with these initial symbols, the clusters comprised in the spatial range may be identified and (at least in part) retrieved from the database. It is noted that such querying may also occur if the exact cluster coordinate is known, since other parts of the key name may be unknown, e.g., block offsets encoded in the key name. In this case, the query may only return a single result, which may be then used to retrieve the cluster.

Optionally, the space-filling curve function is a Z-ordering function. Such Z-ordering maps multidimensional data to one dimension while preserving locality of the data points, and is known per se from the fields of mathematical analysis and computer science, where it is also known as Morton order or Morton code.

Optionally, the set of instructions, when executed by the processor, cause the processor to partition the spatial data into the blocks on the basis of coefficient partitions of a wavelet transformation of the spatial data. By deriving the blocks from a wavelet transformation of the spatial data, a hierarchical data set may be obtained which is partitioned in accordance with frequency and position. For example, one or more clusters may represent lower frequency components of the spatial data, while one or more other clusters may represent its higher frequency components. The spatial data may thus be stored and retrieved in a hierarchical manner, e.g., stored and retrieved according to frequency scale. It will be appreciated that the wavelet transformation may be a recursive wavelet transformation.

Optionally, the set of instructions, when executed by the processor, cause the processor to include in each cluster a redundant low pass coefficient block of the wavelet transformation of the spatial data. By including a redundant low pass coefficient block of the wavelet transformation of the spatial data in each cluster, the reconstruction of each scale of the cluster may be possible, even if the cluster does not comprise all scales of the wavelet hierarchy. This may be particularly advantageous when reconstructing spatial data from a cluster in a streaming manner, as storing the low pass coefficients in each cluster allows a reconstruction, e.g., inverse wavelet transform, of the original spatial data from only the coefficients in that cluster. In particular, for recursive wavelet transformations of very large images (e.g., pathology slides may have 9 or more recursive transforms, also called levels or scales), reconstructing a part of the image would typically require data from all blocks/clusters covering all recursive scales for that area/volume. This may be particularly disadvantageous for streaming reconstruction of image data, as the top recursive levels area may be created at a later time in the recursive transformation process, and thus are found much further downstream in the stream. By allowing each cluster to be reconstructed to an (sub) image, stream consumers may reconstruct (parts of) an image so that processing on the image may be performed. The above problem may therefore be avoided.

Optionally, the set of instructions, when executed by the processor, cause the processor to, before storing a respective cluster as value data in the database, order the data of each block of the cluster using a significance ordering function, wherein the significance ordering function is represented by second function data in the memory. As such, the second function data may comprise instructions for the processor to perform the function. A lower quality reconstruction of the spatial data may be possible by dropping, e.g., not storing and/or not retrieving from the database, lower significance data of each block. Additionally or alternatively, compressed data within the bock may be ordered from most significant to least significant, with the relative position of bitplanes being stored in separate metadata field. The ordering of the data may be part of data compression of the data of the respective cluster

Optionally, the set of instructions, when executed by the processor, cause the processor to store a header of the spatial data as value data in the database, and optionally, store the header before storing the clusters in the database. The header may comprise information describing the spatial data, e.g., dimensions of the spatial data, data ranges, etc., yet without comprising indexing information. As such, the header may be smaller in size than a conventional header which comprises such indexing information. The header may be stored and retrieved as a separate key-value object in the database. By storing the header before the spatial data in the database, this may allow reasoning and/or routing of the subsequently generated objects when storing said objects in the database. Namely, by intercepting store requests on the interface of the database, the key-value pair can be routed or processed based on information in the key combined with information in the already stored (or passed through) header. A non-limiting example of such intercepting is the intercepting of HTTP PUT commands in case the database is a Restful cloud database.

It will be appreciated by those skilled in the art that embodiments, implementations, and/or optional aspects of the invention may be combined in any way deemed useful. Modifications and variations of the method(s) and/or the computer readable media, which correspond to the described modifications and variations of the system(s), can be carried out by a person skilled in the art on the basis of the present description.

It will be appreciate that the system and method may be applied to multi-dimensional image data, e.g., two-dimensional (2D), three-dimensional (3D) or four-dimensional (4D) images, acquired by various acquisition modalities such as, but not limited to, standard X-ray Imaging, Computed Tomography (CT), Magnetic Resonance Imaging (MRI), Ultrasound (US), Positron Emission Tomography (PET), Single Photon Emission Computed Tomography (SPECT), Nuclear Medicine (NM), Digital Pathology (whole slide images), and in brightfield, fluorescence or scanning mass spectroscopy.

### BRIEF DESCRIPTION OF THE DRAWINGS

These and other aspects of the invention will be apparent from and elucidated further with reference to the embodiments described by way of example in the following description and with reference to the accompanying drawings, in which

FIG. 1 shows a system configured to store image data in a key-value database, and/or to retrieve the image data from the key-value database;

FIG. 2 illustrates the storage of the image data in the key-value database as key-value objects which each comprise key data and accompanying value data;

FIG. 3 illustrates a spatial partitioning of the image into blocks, and a grouping of groups of adjacent blocks into clusters;

FIG. 4 shows a method for storing image data in a key-value database;

FIG. 5 shows a method for retrieving image data from a key-value database;

FIG. 6 shows a computer readable medium comprising instructions for causing a processor system to perform the method.

It should be noted that the figures are purely diagrammatic and not drawn to scale. In the figures, elements which correspond to elements already described may have the same reference numerals.

### LIST OF REFERENCE NUMBERS

The following list of reference numbers is provided for facilitating the interpretation of the drawings and shall not be construed as limiting the claims.
020 database
022 database communication
030 key data
031-036 individual key data
040 value data
041-046 individual value data
050 key-value object
060 image
070 cluster
080 block
100 system for storing and/or retrieving image data
120 database interface
122 internal data communication
140 processor
142 internal data communication
160 memory
200 method for storing image data in database
210 partitioning image data into blocks
220 grouping blocks into clusters
230 storing each cluster
240 storing cluster as value data in database
250 generating identifier of cluster
260 generating key data comprising identifier
270 storing key data in database
300 method for retrieving image data from database
310 retrieving block(s) of cluster
320 generating at least part of identifier of cluster
330 querying database for key data
340 selecting key data
350 retrieving corresponding value data from database
400 computer readable medium
410 non-transitory data representing instructions

### DETAILED DESCRIPTION OF EMBODIMENTS

The following description refers to the spatial data being image data. However, this is not a limitation, as instead of image data, any other type of spatial data may be stored and retrieved from the database in the described manner. Examples of other types of spatial data include, e.g., raw MRI data which is sampled in so-called k-space. As such, the following references to ‘image data’ may be understood to equally refer to ‘spatial data’.

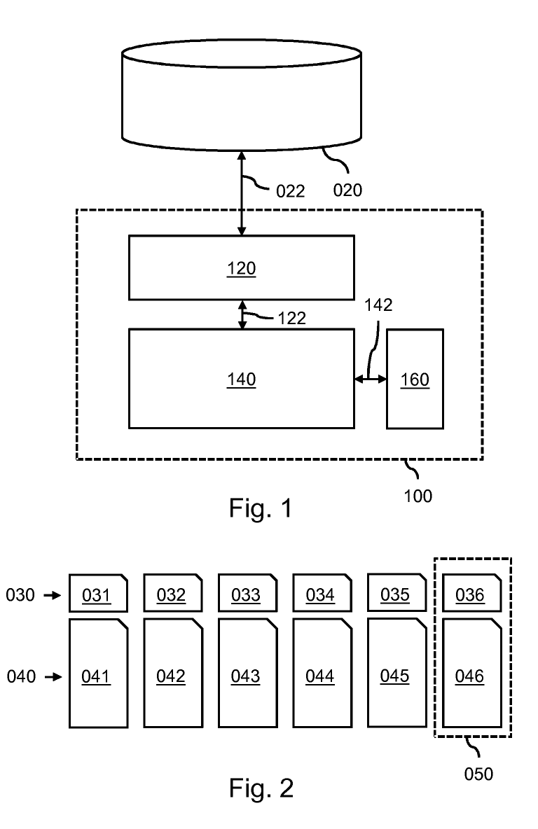

FIG. 1 shows a system 100 which may be configured to store image data in a key-value database, and/or to retrieve the image data from the key-value database. As such, the system 100 may be configured to perform either of these functions, e.g., store or retrieve, or both functions. FIG. 1 further shows a database 020. The database may be a key-value database, also referred to as key-value store, which is configured to store value data in relation to key data and to allow retrieval of the value data on the basis of the key data. A non-limiting example is that the database 020 may be a cloud-hosted database, including but not limited to Amazon S3, Google cloud storage and Openstack SWIFT.

The system 100 is further shown to comprise a database interface 120 configured to access the database 020. The data interface 120 may take various forms, such as a network interface to a local or wide area network, e.g., the Internet, a storage interface to an internal or external data storage, etc. In particular, the database interface 120 may be of a type which matches the access to the database 020. For example, if the database 020 is accessible via a network, the database interface 120 may be constituted by a network interface, if the database 020 is comprised on an internal data storage of the system 100, the database interface 120 may be constituted by an internal storage interface, etc.

The system 100 is further shown to comprise a processor 140 configured to internally communicate with the database interface 120 via data communication 122 and a memory 160 accessible by the processor 140 via data communication 142. The memory 160 may comprise instruction data representing a set of instructions which configures the system 100 to store image data in the database 020, to retrieve the image data from the database 020, or to perform both functions, e.g., the storing and retrieving of the image data.

When configured to store image data, the set of instructions, when executed by the processor 140, may cause the processor 140 to partition image data into blocks, group the blocks into clusters, and store each cluster in the database 020 by causing the processor to: store a respective cluster as value data in the database 020, generate an identifier of the cluster on the basis of a coordinate of the respective cluster, wherein the coordinate is defined with respect to a coordinate system associated with the image data, generate key data for the value data of the cluster, wherein the key data comprises at least the identifier of the cluster, and store the key data in relation to the value data in the database.

When configured to retrieve image data, the set of instructions, when executed by the processor 140, may cause the processor 140 to retrieve one or more blocks of a cluster of the image data from the database 020 by causing the processor 140 to generate at least part of an identifier of the cluster on the basis of a coordinate of the cluster in the coordinate system associated with the image data, query the database for key data comprising the at least part of the identifier, thereby obtaining one or more key data, select a key data of the one or more key data and retrieve at least part of value data from the database which is stored in the database in relation to the key data.

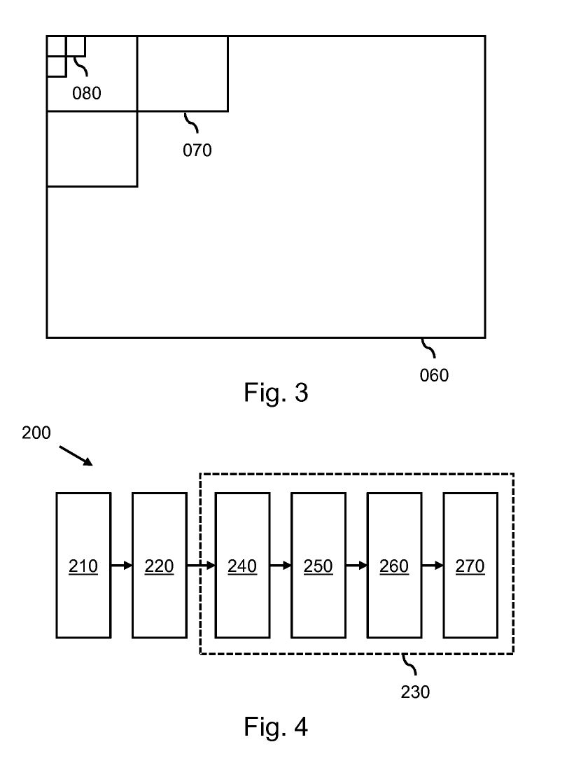

Both configurations will be further explained with reference to FIGS. 2 and 3. It is noted that here, and throughout the specification, a reference to the term ‘image’ may be understood as a reference to the data representation of the image, e.g., the image data. It is further noted that, although not shown in FIG. 1, the system 100, when configured to store image data in the database 020, may initially access the image data in another format, e.g., as a single file, on a data storage. The data storage may be an internal or external image repository, including but not limited to a Picture Archiving and Communication System (PACS) of a Hospital Information System (HIS). For accessing the image repository, the system 100 may comprise an image interface (not shown in FIG. 1) which may be of any suitable type, e.g., a network interface to a local or wide area network, a storage interface to an internal or external data storage, etc. In particular, the image interface may be of a type which matches the access to the image repository. For example, if the image repository is accessible via a network, the image interface may be constituted by a network interface, if the image repository is comprised on an internal data storage of the system 100, the image interface may be constituted by an internal storage interface, etc.

In general, the system 100 of FIG. 1 may be embodied as—or in—a device or apparatus, such as a workstation or imaging apparatus. The device or apparatus may comprise one or more (micro)processors which execute appropriate software. The processor 140 of the system may be embodied by one or more of these (micro)processors. Software implementing, e.g., the storing of image data, the retrieving of image data and/or other functionality of the system, may have been downloaded and/or stored in a corresponding memory 160 or memories, e.g., in volatile memory such as RAM or in non-volatile memory such as Flash. Alternatively, the processor of the system may be implemented in the device or apparatus in the form of programmable logic, e.g., as a Field-Programmable Gate Array (FPGA). The database interface and the optional image interface may be implemented by respective interfaces of the device or apparatus. In general, each unit of the system may be implemented in the form of a circuit. It is noted that the system may also be implemented in a distributed manner, e.g., involving different devices or apparatuses. For example, the distribution of the system may be in accordance with a client-server model.

FIG. 2 illustrates the storage of the image data in the key-value database as key-value objects which each comprise key data and accompanying value data. Namely, a plurality of key-value objects 050 are shown which each comprise key data 030-036 and associated value data 040-046. The image data may be stored in these key-value objects 050 as follows. With continued reference to FIG. 2 while further referring to FIG. 3, the image data 060 may be partitioned into blocks 080. In the example of FIG. 3, the image data 060 is shown to be of a two-dimensional image, but this is not a limitation. Such partitioning may be in accordance with a regular grid, yielding blocks of, e.g., 8×8 or 16×16 pixels, voxels or other image elements. However, the blocks may also have any other suitable shape, lie on an irregular grid, and/or may not even need to comprise adjacent image elements. Having partitioned the image data 060 into blocks 080, the blocks 080 may be grouped into clusters 070 which each comprise one or more of these blocks 080. A specific yet non-limiting example may be that a cluster may comprise 4×4 or 8×8 blocks. Each cluster 070 may then be stored in the database 020 as a key-value object as follows. The image data of the cluster 070 may be stored as value data 041-046 in the database 020. Moreover, an identifier of the cluster 070 may be calculated on the basis of a coordinate of the set of blocks 080 of the respective cluster, wherein the coordinate is defined with respect to a coordinate system associated with the image data 060. Moreover, key data 031-036 may be generated for the value data, with the key data comprising at least the identifier of the cluster. The key data 031-036 may then be stored in relation to the value data 041-046 in the database.

A specific example is that the coordinates of the top left block in each cluster may be used as the identifier of the cluster. In general, such coordinates may be with reference to a block grid, to a grid associated with the image elements, etc. The coordinate system associated with the image data may comprises at least one of: one or more spatial axis indicative of a spatial coordinate of each block, a color axis indicative of which color component the image data comprised in each block represents, and a wavelength axis indicative of which wavelength, or wavelength range, the image data comprised in each block represents. Various other axis of the coordinate system are equally conceivable.

The key data 031-036 may be generated to, in addition to the identifier, further comprise data offsets which represent respective positions of each block 080, or at least of a subset, of the set of blocks of the cluster 070 in the value data 041-046. Such data offsets may be, e.g., byte offsets to the positions of the individual blocks in the cluster value data, and may be base64-encoded in an offset table. In generating the identifier of the cluster, the coordinate may be encoded using a space-filling curve, e.g., using a Z-ordering function. A specific example of the key data of a cluster, in the following also referred to as cluster key, may be the following:

Cluster key [max 1024 chars]:

### [UUID][delimiter][clustercoordinate][delimiter][clustertemplateID][blockoffsets]

Here, the ‘UUID’ may be a universally unique identifier (UUID) of the image. The delimiter may be any suitable delimiter. The ‘clustercoordinate’ may be the Z-ordered encoding of the coordinates of the cluster. The ‘clustertemplateID’ may optionally describe the cluster type, which may not be unique for each cluster, but rather shared between all clusters that have the same value for the properties described in the template. For example, a typical 2D image may have 10 cluster templates describing different types of clusters, with each type having a different ‘clustertemplateID’. An example would be for instance color. If clusters contain all blocks for a certain region in all possible colors, e.g., RGB, then the cluster template ma contain a description of the color space. Additional description may be the data compression method used, and the bit depth of the image data in the cluster, etc. Similarly to the ‘clustertemplateID’, each block may have a ‘blocktemplateID’. The ‘block offsets’ may be the optional data offsets of the blocks in the value data.

Although not shown in FIG. 3, the image data may be partitioned into the blocks on the basis of coefficient partitions of a (recursive) wavelet transformation of the image data. For example, each block within a cluster may represent a different part of the image, whereas each cluster may represent a different frequency scale of the image. In particular, each cluster may comprise blocks at different scales (e.g., spatial frequencies), and each cluster may cover different scales but also different positions in the image. To allow independent decoding of the frequency scales, a redundant low pass coefficient block of the wavelet transformation of the image data may be included in the value data of each cluster.

In general, before storing a respective cluster as value data in the database, the data of each block of the cluster may be ordered using a significance ordering function. For example, if the data of a block is represented by wavelet coefficients, the wavelet coefficients may be ordered in terms of significance. As such, a lower quality reconstruction of the image may be possible by dropping lower significance information. Any known significance ordering function may be used as known per se from the field of computer science. The significance ordering function may be selected based on the type of data of a block. In general, a header of the image data may be stored as value data in the database, e.g., as a separate key-value object. Although the header may omit conventional indexing information for retrieving the blocks from the database, the header may comprise, e.g., dimensions of the data set being stored, e.g., the image, a list of Z-ordered dimensions, e.g., as used in Z-ordered encoding of the coordinates of a cluster, a list of dimensions of a cluster, a list of dimensions of a block, etc. The header may be encoded as XML. The header may be stored by the system in the database before storing the clusters in the database.

In general, to access the database and to store and retrieve image data therefrom, an Application Programming Interface (API) may be used. For example, if the database is provided or represented by a database of the Amazon Web Services (AWS) Simple Storage Service (S3), e.g., a ‘cloud database’, the API may be the S3 API.

FIG. 4 shows a method 200 for storing image data in a database. The database may be of a type as described with reference to FIG. 1, e.g., a key-value database. The method 200 may correspond to an operation of the system 100 of FIG. 1, although this is not a limitation as the method may also be performed by another system, apparatus or device.

The method 200 may comprise, in an operation titled “PARTITIONING IMAGE DATA INTO BLOCKS”, partitioning 210 the image data into blocks. The method 200 may further comprise, in an operation titled “GROUPING BLOCKS INTO CLUSTERS”, grouping 220 the blocks into clusters. The method 200 may further comprise, in an operation titled “STORING EACH CLUSTER”, storing 230 each cluster in the database by, in an operation titled “STORING CLUSTER AS VALUE DATA IN DATABASE”, storing 240 a respective cluster as value data in the database, in an operation titled “GENERATING IDENTIFIER OF CLUSTER”, generating 250 an identifier of the cluster on the basis of a coordinate of the respective cluster, wherein the coordinate is defined with respect to a coordinate system associated with the image data, in an operation titled “GENERATING KEY DATA COMPRISING IDENTIFIER”, generating 260 key data for the value data of the cluster, wherein the key data comprises at least the identifier of the cluster, and in an operation titled “STORING KEY DATA IN DATABASE”, storing 270 the key data in relation to the value data in the database.

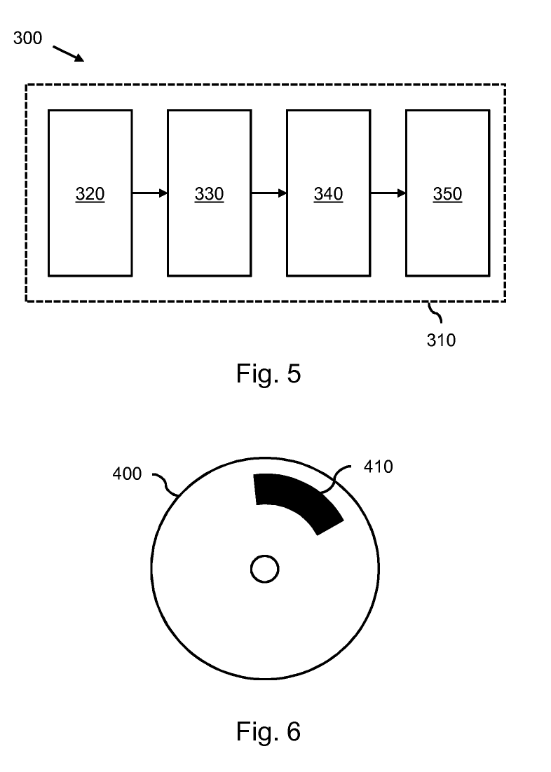

FIG. 5 shows a method 300 for retrieving image data from a database. The database may be of a type as described with reference to FIG. 1, e.g., a key-value database, and may comprise image data stored by the system 100 of FIG. 1 or the method 200 of FIG. 4. The method 300 may correspond to an operation of the system 100 of FIG. 1, although this is not a limitation as the method may also be performed by another system, apparatus or device. The method 300 may comprise, in an operation titled “RETRIEVING BLOCK(S) OF CLUSTER”, retrieving 310 one or more blocks of a cluster of the image data from the database by, in an operation titled “GENERATING AT LEAST PART OF IDENTIFIER OF CLUSTER”, generating 320 at least part of an identifier of the cluster on the basis of a coordinate of the cluster in the coordinate system associated with the image data, in an operation titled “QUERYING DATABASE FOR KEY DATA”, querying 330 the database for key data comprising the at least part of the identifier, thereby obtaining one or more key data, in an operation titled “SELECTING KEY DATA”, selecting 340 a key data of the one or more key data, and in an operation titled “RETRIEVING CORRESPONDING VALUE DATA FROM DATABASE” retrieving 350 at least part of value data from the database which is stored in the database in relation to the key data.

The method 200 of FIG. 4 and the method 300 of FIG. 5 may each be implemented on a computer as a computer implemented method, as dedicated hardware, or as a combination of both. As also illustrated in FIG. 6, instructions for the computer, e.g., executable code, may be stored on a computer readable medium 400, e.g., in the form of a series 410 of machine readable physical marks and/or as a series of elements having different electrical, e.g., magnetic, or optical properties or values. The executable code may be stored in a transitory or non-transitory manner. Examples of computer readable mediums include memory devices, optical storage devices, integrated circuits, servers, online software, etc. FIG. 6 shows an optical disc 400. With continued reference to FIG. 6, the computer readable medium 400 may alternatively or additionally comprise transitory or non-transitory data 410 representing the database in a configuration as described in this specification, with the database comprising stored key data and stored value data as described in this specification.

Examples, embodiments or optional features, whether indicated as non-limiting or not, are not to be understood as limiting the invention as claimed.

It will be appreciated that the invention also applies to computer programs, particularly computer programs on or in a carrier, adapted to put the invention into practice. The program may be in the form of a source code, an object code, a code intermediate source and an object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other. An embodiment relating to a computer program product comprises computer-executable instructions corresponding to each processing stage of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a data storage, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or stages other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system configured to store spatial data in a database, comprising:
a database interface configured to access the database, wherein the database is a key-value database configured to store value data in relation to key data and to allow retrieval of the value data on the basis of the key data;
a memory comprising instruction data representing a set of instructions;
a processor configured to communicate with the database interface and the memory and to execute the set of instructions, wherein the set of instructions, when executed by the processor, cause the processor to:
partition the spatial data into blocks of spatial data;
group the blocks of spatial data into clusters of spatial data; and
store each cluster in the database by causing the processor to:
store a respective cluster as value data in the database;
generate an identifier of the cluster on the basis of a coordinate of the respective cluster, wherein the coordinate is defined with respect to a coordinate system associated with the image data;
generate key data for the value data of the cluster, wherein the key data comprises at least the identifier of the cluster; and
store the key data in relation to the value data in the database.

2. The system according to claim 1, wherein the set of instructions, when executed by the processor, cause the processor to further include in the key data:
data offsets which represent respective positions of each block, or at least of a subset, of the set of blocks of the cluster in the value data.

3. The system according to claim 1, wherein the coordinate system associated with the spatial data comprises at least one of:
a spatial axis indicative of a spatial coordinate of a cluster;
a color axis indicative of a color component which is represented by the spatial data comprised in a cluster; and
a wavelength axis indicative of a wavelength, or wavelength range, which is represented by the spatial data comprised in a cluster.

4. The system according to claim 1, wherein the set of instructions, when executed by the processor cause the processor to:
generate the identifier of the cluster by encoding the coordinate using a space-filling curve function, wherein the space-filling curve function is represented by first function data in the memory.

5. The system according to claim 4, wherein the space-filling curve function is a Z-ordering function.

6. The system according to claim 1, wherein the set of instructions, when executed by the processor, cause the processor to:
partition the spatial data into the blocks on the basis of coefficient partitions of a wavelet transformation of the spatial data.

7. The system according to claim 6, wherein the set of instructions, when executed by the processor, cause the processor to:
include in each cluster a redundant low pass coefficient block of the wavelet transformation of the spatial data.

8. The system according to claim 1, wherein the set of instructions, when executed by the processor, cause the processor to:
before storing a respective cluster as value data in the database, order the data of each block of the cluster using a significance ordering function, wherein the significance ordering function is represented by second function data in the memory.

9. The system according to claim 1, wherein the set of instructions, when executed by the processor, cause the processor to:
store a header of the spatial data as value data in the database; and
optionally, store the header before storing the clusters in the database.

10. A system configured to retrieve spatial data from a database, comprising:
a database interface configured to access the database, wherein the database is a key-value database configured to store value data in relation to key data and to allow retrieval of the value data on the basis of the key data, wherein the database comprises:
stored value data each representing a respective cluster generated by partitioning the spatial data into blocks and grouping the blocks into clusters;
stored key data for each stored value data comprising at least an identifier of the respective cluster, wherein the identifier of the cluster is generated on the basis of a coordinate of the respective cluster, wherein the coordinate is defined with respect to a coordinate system associated with the spatial data;
a memory comprising instruction data representing a set of instructions;
a processor configured to communicate with the database interface and the memory and to execute the set of instructions, wherein the set of instructions, when executed by the processor, cause the processor to:
retrieve one or more blocks of a cluster of the spatial data from the database by causing the processor to:
generate at least part of an identifier of the cluster on the basis of a coordinate of the cluster in the coordinate system associated with the spatial data;
query the database for key data comprising the at least part of the identifier, thereby obtaining one or more key data;
select a key data of the one or more key data; and
retrieve at least part of value data from the database which is stored in the database in relation to the key data.

11. A workstation or imaging apparatus comprising the system according to claim 1.

12. A method for storing spatial data in a database, wherein the database is a key-value database configured to store value data in relation to key data and to allow retrieval of the value data on the basis of the key data, wherein the method comprises:
partitioning the spatial data into blocks of spatial data;
grouping the blocks of spatial data into clusters of spatial data; and
storing each cluster in the database by:
storing a respective cluster as value data in the database;
generating an identifier of the cluster on the basis of a coordinate of the respective cluster, wherein the coordinate is defined with respect to a coordinate system associated with the spatial data;
generating key data for the value data of the cluster, wherein the key data comprises at least the identifier of the cluster; and
storing the key data in relation to the value data in the database.

13. A method for retrieving spatial data from a database, wherein the database is a key-value database configured to store value data in relation to key data and to allow retrieval of the value data on the basis of the key data, wherein the database comprises:
stored value data each representing a respective cluster generated by partitioning the spatial data into blocks and grouping the blocks into clusters;
stored key data for each stored value data comprising at least an identifier of the respective cluster, wherein the identifier of the cluster is generated on the basis of a coordinate of the respective cluster, wherein the coordinate is defined with respect to a coordinate system associated with the spatial data;
wherein the method comprises retrieving one or more blocks of a cluster of the spatial data from the database by:
generating at least part of an identifier of the cluster on the basis of a coordinate of the cluster in the coordinate system associated with the spatial data;
querying the database for key data comprising the at least part of the identifier, thereby obtaining one or more key data;
selecting a key data of the one or more key data; and
retrieving at least part of value data from the database which is stored in the database in relation to the key data.

14. A computer readable medium comprising transitory or non-transitory data representing instructions arranged to cause a processor system to perform the method according to claim 12.

15. A computer readable medium comprising transitory or non-transitory data representing a database, wherein the database is a key-value database configured to store value data in relation to key data and to allow retrieval of the value data on the basis of the key data, wherein the database comprises:
stored value data each representing a respective cluster generated by partitioning the spatial data into blocks and grouping the blocks into clusters;
stored key data for each stored value data comprising at least an identifier of the respective cluster, wherein the identifier of the cluster is generated on the basis of a coordinate of the respective cluster, wherein the coordinate is defined with respect to a coordinate system associated with the spatial data.

16. A computer readable medium, comprising transitory or non-transitory data representing instructions arranged to cause a processor system to perform the method according to claim 13.

17. A workstation or imaging apparatus comprising the system according to claim 2.

18. A workstation or imaging apparatus comprising the system according to claim 3.

19. A workstation or imaging apparatus comprising the system according to claim 4.

20. A workstation or imaging apparatus comprising the system according to claim 5.
